(19) United States
(12) Patent Application Publication
(10) Pub. No.: US 2024/0211535 A1
(43) Pub. Date: Jun. 27, 2024

(54) SPARSE MATRIX ACCELERATED COMPUTING METHOD AND APPARATUS, DEVICE, AND MEDIUM

(71) Applicant: Inspur Suzhou Intelligent Technology Co., Ltd., Suzhou (CN)

(72) Inventor: Linlin YANG, Suzhou (CN)

(73) Assignee: Inspur Suzhou Intelligent Technology Co., Ltd., Suzhou, JS (CN)

(21) Appl. No.: 18/270,152

(22) PCT Filed: Nov. 29, 2021
(86) PCT No.: PCT/CN2021/134145

§ 371 Date: Jun. 28, 2023

(30) Foreign Application Priority Data
Jan. 8, 2021 (CN) 202110024925.X

(51) Int. Cl. G06F 17/16

(52) U.S. Cl. CPC G06F 17/16

(57) ABSTRACT

A sparse matrix accelerated computing method and apparatus, a device, and a medium are disclosed. The method includes: reading and performing non-zero detection on a first sparse matrix, and generating first status information of each line of data of the first sparse matrix by the detection result and storing same into a register; storing non-zero data of the first sparse matrix into an RAM; reading and performing non-zero detection on a second sparse matrix, and generating second status information of each row of data of the second sparse matrix by a detection result and storing same into the register; and performing a logical operation on the first status information and the second status information, reading the data in the RAM by the logical operation result, and performing a product operation on the data in the RAM and data of the second sparse matrix to obtain product matrix data.

### CROSS-REFERENCE TO RELATED APPLICATION

This application claims priority to Chinese Patent Application No. CN202110024925.X, filed on Jan. 8, 2021 in China National Intellectual Property Administration and entitled “Sparse Matrix Accelerated Computing Method and Apparatus, Device, and Medium”, which is hereby incorporated by reference in its entirety.

### FIELD

The present application relates to the field of sparse matrices, in particular to a sparse matrix accelerated computing method and apparatus, a device, and a medium.

### BACKGROUND

A matrix in which elements with a zero value are far more than non-zero elements and distribution of the non-zero elements is irregular is referred to as a sparse matrix. Sparse matrices are produced in almost all large scientific and engineering computing fields, including hot fields such as artificial intelligence, big data, and image processing, and fields such as computational fluid dynamics, statistical physics, circuit simulation, image processing, and even universe exploration. The sparse matrices are data processing objects that often appear in operation processes of a processor, and are usually multiplied by the processor.

At present, existing matrix product operations are mainly implemented through software, whereby a computing process is slow, real-time processing requirements cannot be met, and storage space is wasted.

### SUMMARY

In view of this, it is necessary for above technical problems to provide a sparse matrix accelerated computing method and apparatus, a device, and a medium that may reduce use of on-chip resources.

According to a first aspect of the present application, a sparse matrix accelerated computing method is provided, the method including:
reading a first sparse matrix to be multiplied, performing non-zero detection on the first sparse matrix, and generating first status information of each line of data of the first sparse matrix according to a detection result and storing same into a register;
storing detected non-zero data of the first sparse matrix into a RAM;
reading a second sparse matrix to be multiplied, performing non-zero detection on the second sparse matrix, and generating second status information of each row of data of the second sparse matrix according to a detection result and storing same into the register; and
performing a logical operation on the first status information and the second status information, reading the non-zero data in the RAM according to the logical operation result, and performing a product operation on the non-zero data in the RAM and the data of the second sparse matrix to obtain data of a product matrix.

In one embodiment, a step of the reading a first sparse matrix to be multiplied, performing non-zero detection on the first sparse matrix, and generating first status information of each line of data of the first sparse matrix according to a detection result and storing same into a register includes:
reading the data of the first sparse matrix by lines;
comparing read data in each line with zero;
marking status bits corresponding to the read data as 0 if the read data are equal to zero;
marking status bits corresponding to the read data as 1 if the read data are not equal to zero; and
arranging the status bit marks of a plurality of data in each line in ascending order of row numbers to obtain the first status information and storing same into the register.

In one embodiment, a step of the storing detected non-zero data of the first sparse matrix into a RAM includes:
dividing the RAM into a plurality of sub-RAMs; and
storing the non-zero data in a same line and row numbers of the non-zero data into a same sub-RAM in ascending order of the row numbers, generating an address code table of a corresponding relationship between a row number of each non-zero data in each line and a storage address of the sub-RAM, and generating a table of a corresponding relationship between a line number of each non-zero line and each sub-RAM.

In one embodiment, a step of the reading a second sparse matrix to be multiplied, performing non-zero detection on the second sparse matrix, and generating second status information of each row of the data of the second sparse matrix according to a detection result and storing same into the register includes:
Reading the data of the second sparse matrix by rows;
comparing read data from a plurality of data in each row with zero;
marking status bits corresponding to the read data as 0 if the read data are equal to zero;
marking the status bits corresponding to the read data as 1 if the read data are not equal to zero; and
arranging the status bit marks of the plurality of data in each row in ascending order of line numbers to obtain the second status information and storing same into the register.

In one embodiment, a step of the performing a logical operation on the first status information and the second status information, reading the non-zero data in the RAM according to a logical operation result, and performing a product operation on the non-zero data in the RAM and the data of the second sparse matrix to obtain data of a product matrix includes:
performing a bitwise AND operation on the second status information of a row of the second sparse matrix and each piece of first status information of the first sparse matrix;
in response to a detection that the a bitwise AND operation result is not equal to zero, obtaining bit numbers of status bit marks equal to 1 in the bitwise AND operation results, using a row number of a row as a target row number, and using a line number corresponding to the first status information as a target line number;
determining a target sub-RAM according to a table of corresponding relationships of the target line number and each non-zero line number with each sub-RAM;
matching the bit numbers with the address code table of the corresponding relationship between the row number of each non-zero data in each line and the storage address of the sub-RAM to determine first target data, and matching the bit numbers with the line numbers of a row of data to determine second target data; and
performing a product operation on the first target data and the second target data corresponding to the same bit number, and accumulating product operation results corresponding to different bit numbers to obtain target data values of the product matrix at the target line number and the target row number.

In one embodiment, the method further includes:
storing the target data values carrying the target line number and the target row number into a DMA, collecting statistics on a quantity of the target data values, and storing statistical values into the register.

In one embodiment, the method further includes:
in response to a completion of the product operation on the first sparse matrix and the second sparse matrix, generating an interrupt signal, and reading the statistical values in the register by using upper software; and
reading, according to the statistical values, the target data in the DMA and the target line number and target row number carried by the target data.

According to a second aspect of the present application, a sparse matrix accelerated computing apparatus is provided, the apparatus including:
a first reading module, configured to read a first sparse matrix to be multiplied, perform non-zero detection on the first sparse matrix, and generate first status information of each line of data of the first sparse matrix according to the detection result and store same into a register;
a non-zero data storage module, configured to store detected non-zero data of the first sparse matrix into a RAM;
a second reading module, configured to read a second sparse matrix to be multiplied, perform non-zero detection on the second sparse matrix, and generate second status information of each row of data of the second sparse matrix according to the detection result and store same into the register; and
a product operation module, configured to perform a logical operation on the first status information and the second status information, read the non-zero data in the RAM according to the logical operation result, and perform a product operation on the non-zero data in the RAM and data of the second sparse matrix to obtain data of a product matrix.

According to a third aspect of the present application, a computer device is further provided, including a memory and one or more processors, the memory storing computer-readable instructions, and the one or more processors being enabled to execute the foregoing sparse matrix accelerated computing method when the computer-readable instructions are executed by the one or more processors.

According to a fourth aspect of the present application, one or more non-transitory computer-readable storage media storing computer-readable instructions are further provided, one or more processors being enabled to execute the foregoing sparse matrix accelerated computing method when the computer-readable instructions are executed by the one or more processors.

Details of one or more embodiments of the present application are set forth in the following accompanying drawings and description. Other features and advantages of the present application will become apparent from the specification, the drawings and the claims.

### BRIEF DESCRIPTION OF THE DRAWINGS

In order to describe the technical solutions in the embodiments of the present application or in the existing art more clearly, drawings required to be used in the illustration of the embodiments or the existing art will be briefly introduced below. Apparently, the drawings in the illustration below are some embodiments of the present application. Those ordinarily skilled in the art also may obtain other drawings according to the provided drawings without creative work.

FIG. 1 is a schematic flowchart of a sparse matrix accelerated computing method provided by the present application according to one or more embodiments;

FIG. 2 is a schematic diagram of a sparse matrix accelerated computing hardware topology provided by the present application according to one or more embodiments;

FIG. 3 is a schematic structural diagram of a sparse matrix accelerated computing apparatus provided by the present application according to one or more embodiments; and

FIG. 4 is an internal structural diagram of a computer device provided by the present application according to one or more embodiments.

### DETAILED DESCRIPTION

In order to make objectives, technical solutions and advantages of the present application clearer, embodiments of the present application will be further described in detail with reference to embodiments and the accompanying drawings.

It should be noted that all expressions using “first” and “second” in the embodiments of the present application are for distinguishing two different entities or different parameters with a same name. Hence, the expressions “first” and “second” are for convenience of description, and should not be construed as limiting the embodiments of the present application, and subsequent embodiments will not describe this one by one.

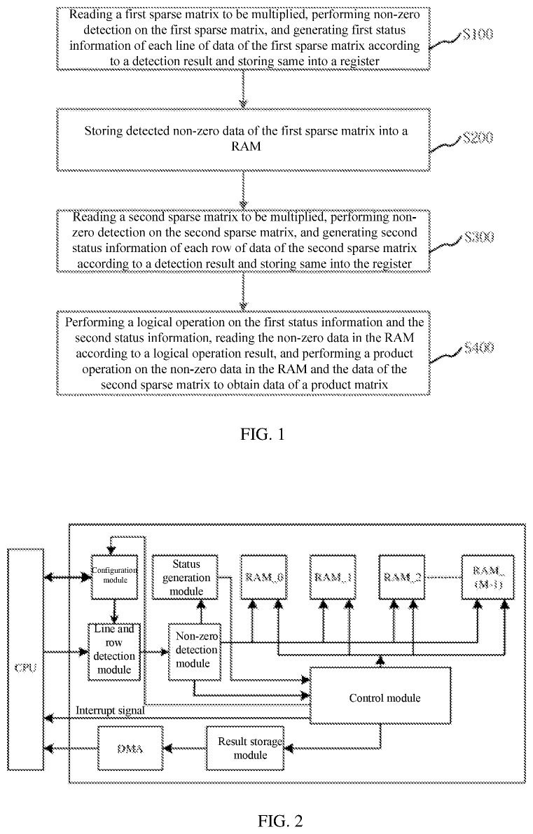

In one embodiment, please refer to FIG. 1, the present application provides a sparse matrix accelerated computing method. The method includes following steps:
S100: reading a first sparse matrix to be multiplied, performing non-zero detection on the first sparse matrix, and generating first status information of each line of data of the first sparse matrix according to a detection result and storing same into a register;
S200: storing detected non-zero data of the first sparse matrix into a RAM;
S300: reading a second sparse matrix to be multiplied, performing non-zero detection on the second sparse matrix, and generating second status information of each row of data of the second sparse matrix according to a detection result and storing same into the register; and
S400: performing a logical operation on the first status information and the second status information, reading the non-zero data in the RAM according to a logical operation result, and performing a product operation on the non-zero data in the RAM and the data of the second sparse matrix to obtain data of a product matrix.

According to the foregoing sparse matrix accelerated computing method, a first sparse matrix to be multiplied is first read, non-zero detection is performed on the first sparse matrix, and first status information of each line of data of the first sparse matrix is generated according to the detection result and stored into a register; non-zero data of the first sparse matrix are stored into a RAM (Random Access Memory); then a second sparse matrix to be multiplied is read, non-zero detection is performed on the second sparse matrix, and second status information of each row of data of the second sparse matrix is generated according to the detection result and stored into the register; and finally a logical operation is performed on the first status information and the second status information, the data in the RAM are read according to the logical operation result, and a product operation is performed on the data in the RAM and data of the second sparse matrix to obtain data of a product matrix, whereby the method of the present application stores non-zero data of the first sparse matrix, and does not need to store the second sparse matrix, which greatly saves an on-chip resource space, reduces a volume of data read in a computing process, and improves the processing speed of sparse matrix computation.

In another embodiment, step S100 above includes:
S110: reading the data of the first sparse matrix by lines;
S120: comparing the data read in each line with zero;
S130: marking status bits corresponding to the read data as 0 if the read data are equal to zero;
S140: marking the status bits corresponding to the read data as 1 if the read data are not equal to zero; and
S150: arranging the status bit marks of a plurality of data in each line in ascending order of row numbers to obtain the first status information and storing same into the register.

In another embodiment, step S200 above includes:
S210: dividing the RAM into a plurality of sub-RAMs; and
S220: storing the non-zero data in a same line and row numbers of the non-zero data into a same sub-RAM in ascending order of the row numbers, generating an address code table of a corresponding relationship between a row number of each non-zero data in each line and a storage address of the sub-RAM, and generating a table of a corresponding relationship between a line number of each non-zero line and each sub-RAM.

In another embodiment, step S300 includes:
S310: reading the data of the second sparse matrix by rows;
S320: comparing read data from a plurality of data in each row with zero;
S330: marking status bits corresponding to the read data as 0 if the read data are equal to zero;
S340: marking the status bits corresponding to the read data as 1 if the read data are not equal to zero; and
S350: arranging the status bit marks of the plurality of data in each row in ascending order of line numbers to obtain the second status information and storing same into the register.

In another embodiment, step S400 above includes:
S410: performing a bitwise AND operation on the second status information of a row of the second sparse matrix and each piece of first status information of the first sparse matrix;
S420: in response to a detection that the bitwise AND operation result is not equal to zero, obtaining bit numbers of the status bit marks equal to 1 in the bitwise AND operation results, using the row number of a row as a target row number, and using the line number corresponding to the first status information as a target line number;
S430: determining a target sub-RAM according to a table of corresponding relationships of the target line number and each non-zero line number with each sub-RAM;
S440: matching with the address code table to determine first target data, and matching the bit numbers with the line numbers of a row of data to determine second target data; and
S450: performing a product operation on the first target data and the second target data corresponding to the same bit number, and accumulating product operation results corresponding to different bit numbers to obtain target data values of the product matrix at the target line number and the target row number.

In another embodiment, a sparse matrix accelerated computing method further includes:
S500: storing the target data values carrying the target line number and the target row number into a DMA, collecting statistics on a quantity of the target data values, and storing statistical values into the register.

In some embodiments, the method further includes:
S610: in response to the completion of the product operation on the first sparse matrix and the second sparse matrix, generating an interrupt signal, and reading the statistical values in the register by using upper software; and
S620: reading, according to the statistical values, the target data in the DMA (Direct Memory Access) and the target line number and target row number carried by the target data.

In another embodiment, an application of the method to a hardware FPGA (Field-Programmable Gate Array) below is as an example for illustration. Please refer to FIG. 2. FIG. 2 shows a sparse matrix accelerated computing hardware topology, mainly including a configuration module, a line and row detection module, a non-zero detection module, a status generation module, a control module, and a storage module, where the configuration module is configured to receive dimension information of matrices and transmit the information to the line and row detection module; the line and row detection module is configured to receive matrix data and compute line and row numbers of each element according to obtained dimension information; the non-zero detection module is configured to detect non-zero elements in a matrix; the status generation module is configured to generate corresponding status information according to detection results of the non-zero detection module; the control module is configured to obtain corresponding data from a RAM according to the transmitted information and perform a product operation; and the storage module is configured to store the non-zero elements of the matrix and product result data.

In order to facilitate understanding of technical solutions of the present application, a sparse matrix A(M,P), namely, the first sparse matrix, and B(P,N), namely, the second sparse matrix, are described below. A process of computing a product of sparse matrices is as follows:
Step 1: upper software sends dimensions M, P, and N of matrices to be processed to the configuration module, where matrix A has M lines and P rows, and matrix B has P lines and N rows;
Step 2: the upper software sends all data of matrix A, including 0 elements, to the line and row detection module by lines;
Step 3: the line and row detection module computes line/row numbers of matrix A elements, where a computing method is as follows (/ represents a rounding operation, and % represents a remainder operation):

A_line_num=A_data_num/P

A_row_num=A_data_num % P
where A_data_num represents an input count of current elements, starting from 0 and ending at (M*P−1); A_line_num represents computed line numbers of the current elements in matrix A; and A_row_num represents computed row numbers of the current elements in matrix A.
Step 4: matrix A data elements with known line and row number information enter the non-zero detection module, 0 elements are directly discarded and non-zero elements are stored according to determination results, which may improve the computing speed and save on-chip resources. Note that the non-zero elements are stored by lines, and the non-zero elements in a same line are written in a same RAM.

For example, there are three non-zero elements in line 0 of matrix A: 1, 3, and 4, which are in rows 0, 3, and 7 respectively, and the three elements are written into RAM_0. If there is one non-zero element in line 1 of matrix A: 20, which is in row 9, the element is written into RAM_1. If there are 0 non-zero elements in line 2 of matrix A, no elements are written into RAM_2. An address code table is generated when non-zero elements in the current line of A are stored, showing row numbers of the non-zero elements in the current line and a storage address of RAM, for example, address code tables of RAM_0 and RAM_1 are shown in Table 1 and Table 2, respectively.

TABLE 1
Address code table of RAM_0

| Row number | Address of RAM_0 |
|---|---|
| 0 | 0 |
| 3 | 1 |
| 7 | 2 |

TABLE 2
Address code table of RAM_1

| Row number | Address of RAM_1 |
|---|---|
| 9 | 0 |

Step 5: the status generation module generates status information (Line_0_status . . . Line_M−1_status) corresponding to each line of matrix A according to non-zero determination results of each line of elements. If there are three non-zero elements in line 0 and rows 0, 3, and 7 (totally 10 rows) of matrix A and elements in other rows are 0, a value of the corresponding status register in the line is: Line_0_status=10′b10_0100_0100; if there is one non-zero element in line 1 and row 9 of matrix A and elements in other rows are 0, a value of the corresponding status register in the line is: Line_1_status=10′b00_0000_0001; and if there is no non-zero element in a line, a value of the corresponding status register is 10′b00_0000_0000.
Step 6: the upper software sends all data of matrix B, including 0 elements, to the line and row detection module by rows;
Step 7: the line and row detection module computes line/row numbers of matrix B elements, where a computing method is as follows (/ represents a rounding operation, and % represents a remainder operation):

$$B\_line \_num = B\_data \_num / P$$

$$B\_row \_num = B\_data \_num \% P$$

where B_data_num represents an input count of current elements, starting from 0 and ending at (P*N−1); B_line_num represents computed line numbers of the current elements in matrix BT; and B_row_num represents computed row numbers of the current elements in matrix BT (BT is a transposed matrix of B).
Step 8: the matrix B data elements with known line and row number information enter the non-zero detection module, and 0 elements are directly discarded according to determination results.
Step 9: the status generation module generates corresponding status information (Row_1_status . . . Row_N−1_status) of each row of matrix B according to non-zero determination results of each row of element. If there are four non-zero elements in row 1 and lines 1, 3, 7, and 9 (totally 10 lines) of matrix B and elements in other lines are 0, a value of the corresponding status register in the row is: Row_1_status=10′b01_0100_0101; and if there is no non-zero element in a row, a value of the corresponding status register is 10′b00_0000_0000.
Step 10: the control module first processes a first non-zero data row of matrix B. If there is no non-zero data in the current row, no processing is performed to speed up matrix multiplication. If data in row 0 of matrix B are all 0, no product operation is performed. If there are four non-zero elements in row 1 and lines 1, 3, 7, and 9 (totally 10 lines) of matrix B and elements in other lines are 0, a value of the corresponding status register in the row is: Row_1_status=10′b01_0100_0101.

In this case, the control module computes the status information in row 1 of matrix B and in all non-zero lines of matrix A at the same time (bitwise AND):

$$Result\_ 0 \_status = Row\_ 1 \_status \& Line\_ 0 \_status$$

$$Result\_ 1 \_status = Row\_ 1 \_status \& Line\_ 1 \_status$$

$$Result\_M - 1 \_status = Row\_ 1 \_status \& Line\_M - 1 \_status$$

The following will be obtained:

$$Result\_ 0 \_status = {10}^{′} b 01 \_ 0100 \_ 0101 \& {10}^{′} b 10 \_ 0100 \_ 0100 = {10}^{′} b 00 \_ 0100 \_ 0100$$

$$Result\_ 1 \_statu = {10}^{′} b 01 \_ 0100 \_ 0101 \& {10}^{′} b 00 \_ 0000 \_ 0001 = 1 {0}^{′} b 00 \_ 0000 \_ 0001$$

Finally, the control module reads, according to computing results, the corresponding non-zero elements in a table lookup manner for product operation. Mmatrix A data that participate in computations are read, and data that do not participate in the computations are not read, which may improve the computing speed.

For example, addresses 1 and 2 of RAM_0 are read for the result Result_0_status. After the corresponding data are read, the data are multiplied by the corresponding elements in row 1 of matrix B (in lines 3 and 7), then the results are accumulated, (namely, a product of data in address 1 of RAM_0 and data in row 1 and line 3 of matrix B and a product of data in address 2 of RAM_0 and data in row 1 and line 7 of matrix B are computed, and the two products are accumulated), and the final accumulated value carries line and row number information {0, 1, RESULT}, where 0 represents a line number, namely, a line number where the non-zero data of matrix A currently participating in the operation are located, and 1 represents a row number, namely, a row number where the non-zero data of matrix B currently participating in the operation are located. For another example, address 0 of RAM_1 is read for the result Result_1_status.

After the corresponding data are read, the data are multiplied by the corresponding elements (in line 9) in row 1 of matrix B, then the results are accumulated, and the final accumulated value carries line and row number information {1, 1, RESULT}, where the first 1 represents a line number, namely, a line number where the non-zero data of matrix A currently participating in the operation are located, and the second 1 represents a row number, namely, a row number where the non-zero data of matrix B currently participating in the operation are located. After the first non-zero data row of matrix B is processed, the second non-zero data row and all other non-zero data rows of matrix B are processed in the same way. The design provided in the present application does not need to store matrix B data, which greatly saves on-chip resource space.
Step 11: the foregoing computing results are stored in the result storage module; when the control module completes the product operation of matrix A and matrix B, an interrupt signal is generated to notify the upper software to read the computing results; meanwhile, a quantity RESULT_NUM of the current matrix operation results is written into the configuration module, the software reads the corresponding register to learn the quantity of the computing results, then the DMA is configured to generate a DMA read operation that read the corresponding quantity, and all the computing results are read back.
Step 12: a CPU continues to send the next group of sparse matrices for product computation, and the process is repeated from step 1 to step 11. When the product of sparse matrix A and sparse matrix B is computed in the foregoing way, dimensions of the sparse matrices may be flexibly configured, and a small volume of data needs to be stored, which saves on-chip hardware resources. Meanwhile, the parallel product accumulation design further improves the processing speed, and is very suitable for FPGA heterogeneous accelerated sparse matrix computation or sASIC (Application Specific Integrated Circuit) matrix operation chip design.

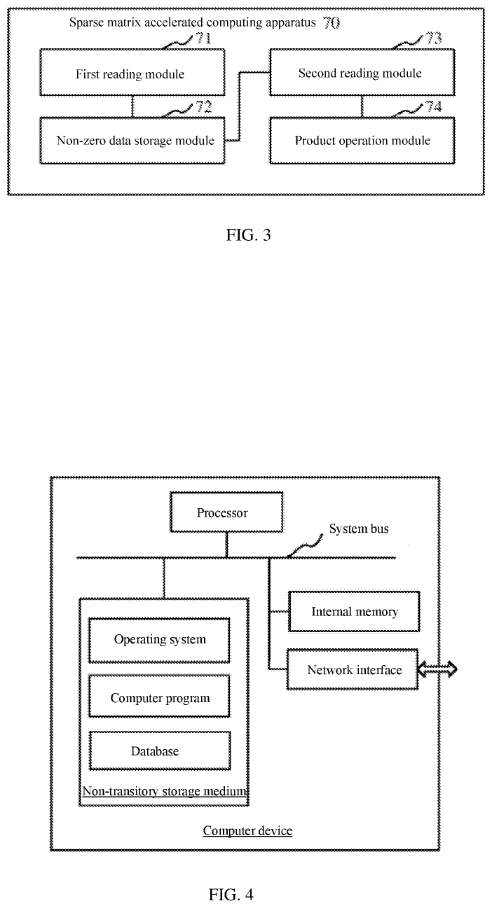

In still another embodiment, with reference to FIG. 3, the present application provides a sparse matrix accelerated computing apparatus 70, the apparatus including:
a first reading module 71, configured to read a first sparse matrix to be multiplied, perform non-zero detection on the first sparse matrix, and generate first status information of each line of data of the first sparse matrix according to the detection result and store same into a register;
a non-zero data storage module 72, configured to store detected non-zero data of the first sparse matrix into a RAM;
a second reading module 73, configured to read a second sparse matrix to be multiplied, perform non-zero detection on the second sparse matrix, and generate second status information of each row of data of the second sparse matrix according to the detection result and store same into the register; and
a product operation module 74, configured to perform a logical operation on the first status information and the second status information, read the non-zero data in the RAM according to the logical operation result, and perform a product operation on the non-zero data in the RAM and data of the second sparse matrix to obtain data of a product matrix.

It should be noted that specific definitions on the sparse matrix accelerated computing apparatus may be referred to the definitions on the sparse matrix accelerated computing method above, and will not be repeated here. The modules in the foregoing sparse matrix accelerated computing apparatus may be implemented in whole or in part by software, hardware, and a combination thereof. The modules may be embedded in or independent of a processor in a computer device in a form of hardware, or stored in a memory of the computer device in a form of software, whereby the processor calls operations corresponding to the modules.

The present application further provides a computer device, including a memory and one or more processors, the memory storing computer-readable instructions, and the one or more processors being enabled to execute the steps of the sparse matrix accelerated computing method in the foregoing embodiments when the computer-readable instructions are executed by the one or more processors.

According to another aspect of the present application, a computer device is provided. The computer device may be a server, and an internal structure of the computer device is shown in FIG. 4. The computer device includes a processor, a memory, a network interface, and a database that are connected by a system bus. The processor of the computer device is configured to provide computing and control capabilities. The memory of the computer device includes a non-transitory storage medium and an internal memory. The non-transitory storage medium stores an operating system, computer-readable instructions, and a database. The internal memory provides an environment for operations of the operating system and the computer-readable instructions in the non-transitory storage medium. The database of the computer device is configured to store data. The network interface of the computer device is configured to communicate with an external terminal through a network connection. When the computer-readable instructions are executed by the processor, the foregoing sparse matrix accelerated computing method is implemented.

The present application further provides one or more non-transitory computer-readable storage media storing computer-readable instructions, one or more processors being enabled to execute the steps of the sparse matrix accelerated computing method in the foregoing embodiments when the computer-readable instructions are executed by the one or more processors.

The computer-readable storage media may include various media capable of storing program code, such as a U disk, a mobile hard disk, a read-only memory (ROM), a random access memory (RAM), a magnetic disk, or an optical disk.

Those of ordinary skill in the art may understand that all or some of the processes in the methods of the foregoing embodiments may be implemented by computer-readable instructions instructing relevant hardware. The computer-readable instructions may be stored in a non-transitory computer-readable storage medium. The computer-readable instructions, when executed, may include the processes of the embodiments of the foregoing methods. Any reference to the memory, storage, database, or other media used in the embodiments provided in the present application may include non-transitory and/or transitory memories. The non-transitory memory may include a read-only memory (ROM), a programmable ROM (PROM), an electrically programmable ROM (EPROM), an electrically erasable programmable ROM (EEPROM), or a flash memory. The transitory memory may include a random access memory (RAM) or an external cache memory. As an illustration and not a limitation, the RAM is available in many forms, such as a static RAM (SRAM), a dynamic RAM (DRAM), a synchronous DRAM (SDRAM), a double data rate SDRAM (DDR SDRAM), an enhanced SDRAM (ESDRAM), a Synchlink DRAM (SLDRAM), a Rambus direct RAM (RDRAM), a direct Rambus dynamic RAM (DRDRAM), and a Rambus dynamic RAM (RDRAM).

The technical features of the above embodiments may be combined arbitrarily. For the purpose of simplicity in description, all the possible combinations of the technical features in the foregoing embodiments are not described. However, as long as the combinations of these technical features do not have contradictions, they shall fall within the scope of the specification.

The foregoing embodiments only describe several implementations of the present application, and their descriptions are detailed, but cannot therefore be understood as limitations to the patent scope of the present application. It should be noted that those of ordinary skill in the art may further make variations and improvements without departing from the conception of the present application, and these all fall within the protection scope of the present application. Therefore, the patent protection scope of the present application should be subject to the appended claims.

1. A sparse matrix accelerated computing method, wherein the method comprises:
reading a first sparse matrix to be multiplied, performing non-zero detection on the first sparse matrix, and generating first status information of each line of data of the first sparse matrix according to a first detection result and storing the first status information into a register;
storing detected non-zero data of the first sparse matrix into a Random Access Memory (RAM);
reading a second sparse matrix to be multiplied, performing non-zero detection on the second sparse matrix, and generating second status information of each row of data of the second sparse matrix according to a second detection result and storing the second status information into the register; and
performing a logical operation on the first status information and the second status information, reading the non-zero data in the RAM according to a logical operation result, and performing a product operation on the non-zero data in the RAM and the data of the second sparse matrix to obtain data of a product matrix.

2. The method according to claim 1, wherein a reading the first sparse matrix to be multiplied, performing the non-zero detection on the first sparse matrix, and generating the first status information of each line of the data of the first sparse matrix according to the first detection result and storing the first status information into the register comprises:
reading the data of the first sparse matrix by lines;
comparing read data in each line with zero;
marking status bits corresponding to the read data as 0 if under a condition that the read data are equal to zero;
marking the status bits corresponding to the read data as 1 if under a condition that the read data are not equal to zero; and
arranging status bit marks of a plurality of data in each line in ascending order of row numbers to obtain the first status information and storing the first status information into the register.

3. The method according to claim 1, wherein storing the detected non-zero data of the first sparse matrix into the RAM comprises:
dividing the RAM into a plurality of sub-RAMs; and
storing the non-zero data in a same line and row numbers of the non-zero data into a same sub-RAM in ascending order of the row numbers, generating an address code table of a corresponding relationship between a row number of each non-zero data in each line and a storage address of the sub-RAM, and generating a table of a corresponding relationship between a line number of each non-zero line and each sub-RAM.

4. The method according to claim 3, reading the second sparse matrix to be multiplied, performing the non-zero detection on the second sparse matrix, and generating the second status information of each row of the data of the second sparse matrix according to the second detection result and storing the second status information into the register comprises:
reading the data of the second sparse matrix by rows;
comparing read data from a plurality of data in each row with zero;
marking status bits corresponding to the read data as 0 under a condition that the read data are equal to zero;
marking the status bits corresponding to the read data as 1 under a condition that the read data are not equal to zero; and
arranging status bit marks of the plurality of data in each row in ascending order of line numbers to obtain the second status information and storing the second status information into the register.

5. The method according to claim 4, wherein performing the logical operation on the first status information and the second status information, reading the non-zero data in the RAM according to the logical operation result, and performing the product operation on the non-zero data in the RAM and the data of the second sparse matrix to obtain the data of the product matrix comprises:
performing a bitwise AND operation on the second status information of a row of the second sparse matrix and each piece of the first status information of the first sparse matrix;
in response to a detection that a bitwise AND operation result is not equal to zero, obtaining bit numbers of status bit marks equal to 1 in the bitwise AND operation result, using a row number of a row as a target row number, and using a line number corresponding to the first status information as a target line number;
determining a target sub-RAM according to a table of corresponding relationships of the target line number and each non-zero line number with each sub-RAM;
matching the bit numbers with the address code table of the corresponding relationship between the row number of each non-zero data in each line and the storage address of the sub-RAM to determine first target data, and matching the bit numbers with the line numbers of a row of data to determine second target data; and
performing a product operation on the first target data and the second target data corresponding to the same bit number, and accumulating product operation results corresponding to different bit numbers to obtain target data values of the product matrix at the target line number and the target row number.

6. The method according to claim 5, wherein the method further comprises:
storing the target data values carrying the target line number and the target row number into a direct memory access (DMA), collecting statistics on a quantity of the target data values, and storing statistical values into the register.

7. The method according to claim 6, wherein the method further comprises:
in response to completion of the product operation on the first sparse matrix and the second sparse matrix, generating an interrupt signal, and reading the statistical values in the register by using upper software; and
reading, according to the statistical values, the target data in the DMA and the target line number and target row number carried by the target data.

8. (canceled)

9. A computer device, comprising:
a memory storing a computer program; and
one or more processors configured to execute the computer program, wherein the one or more processors, upon execution of the computer program, is configured to:
read a first sparse matrix to be multiplied, perform non-zero detection on the first sparse matrix, and generate first status information of each line of data of the first sparse matrix according to a first detection result and store the first status information into a register;
store detected non-zero data of the first sparse matrix into a Random Access Memory (RAM);
read a second sparse matrix to be multiplied, perform non-zero detection on the second sparse matrix, and generate second status information of each row of data of the second sparse matrix according to a second detection result and store the second status information into the register; and
perform a logical operation on the first status information and the second status information, read the non-zero data in the RAM according to a logical operation result, and perform a product operation on the non-zero data in the RAM and the data of the second sparse matrix to obtain data of a product matrix.

10. One or more non-transitory computer-readable storage media storing a computer program executable by a processor, and upon execution by the processor, is configured to cause the processor to:
read a first sparse matrix to be multiplied, perform non-zero detection on the first sparse matrix, and generate first status information of each line of data of the first sparse matrix according to a first detection result and store the first status information into a register;
store detected non-zero data of the first sparse matrix into a Random Access Memory (RAM);
read a second sparse matrix to be multiplied, perform non-zero detection on the second sparse matrix, and generate second status information of each row of data of the second sparse matrix according to a second detection result and store the second status information into the register; and
perform a logical operation on the first status information and the second status information, read the non-zero data in the RAM according to a logical operation result, and perform a product operation on the non-zero data in the RAM and the data of the second sparse matrix to obtain data of a product matrix.

11. The method according to claim 1, wherein the performing the non-zero detection on the first sparse matrix comprises:
obtaining dimensions and all data of the first sparse matrix; and
performing the non-zero detection on the first sparse matrix according to the dimensions and all data of the first sparse matrix.

12. The method according to claim 11, wherein the performing the non-zero detection on the first sparse matrix according to the dimensions and all data of the first sparse matrix comprises:
obtaining a first sparse matrix with known row and line number, according to the dimensions and all data of the first sparse matrix, by computing line numbers and row numbers of the data of the first sparse matrix; and
performing the non-zero detection on the first sparse matrix with known row and line numbers.

13. The method according to claim 12, wherein obtaining the first sparse matrix with known row and line number, according to the dimensions and all data of the first sparse matrix, by computing line numbers and row numbers of the data of the first sparse matrix comprises:
obtaining a number of columns of the first sparse matrix, and an input count of a current element, wherein the input count is obtained by inputting the current element by line; and
performing a remainder operation on the input count through the number of columns to obtain a row number of the current element, and performing a rounding operation on the input count through the number of columns to obtain a line number of the current element.

14. The method according to claim 1, wherein after the generating the first status information of each line of data of the first sparse matrix according to the first detection result and storing the first status information into the register, the method further comprises:
discarding data equal to 0 in the first sparse matrix.

15. The method according to claim 1, wherein the storing the detected non-zero data of the first sparse matrix into the RAM comprises:
storing the detected non-zero data in a same line into a same RAM.

16. The method according to claim 15, wherein storing the detected non-zero data in the same line into the same RAM comprises:
determining target non-zero data in a target line of the first sparse matrix, and a target RAM corresponding to the target line, wherein each line of the first sparse matrix corresponds to a different target RAM; and
storing the target non-zero data in the target RAM.

17. The method according to claim 16, wherein during the storing the detected non-zero data in the same line into the same RAM, the method comprises:
determining an address of the target RAM, and a line number of the target non-zero data stored in the target RAM; and
generating an address code table based on the address of the target RAM and the line number of the target non-zero data stored in the target RAM.

18. The method according to claim 1, wherein the performing the product operation on the non-zero data in the RAM and the data of the second sparse matrix to obtain data of the product matrix comprises:
reading the data of the first sparse matrix by rows; and
in response to a detection that there is no non-zero data in a current row, performing no product operation on the current row.

19. The method according to claim 5, wherein after the accumulating the product operation results corresponding to the different bit numbers to obtain the target data values of the product matrix at the target line number and the target row number, the method further comprises:
obtaining a final accumulated value; and
making the final accumulated value carry a line number where the non-zero data of the first sparse matrix currently participating in an operation and a row number where the non-zero data of the second sparse matrix currently participating in the operation are located.

20. The method according to claim 1, wherein the first sparse matrix and the second sparse matrix are Field-Programmable Gate Array (FPGA) heterogeneous accelerated sparse matrixes.

21. The method according to claim 1, wherein the method is performed during an Application Specific Integrated Circuit (ASIC) matrix operation chip design.
